(19) United States
(12) Patent Application Publication
(10) Pub. No.: US 2006/0033347 A1
(43) Pub. Date: Feb. 16, 2006

(54) Motor vehicle body

(76) Inventors: Andreas Hauger, Attendorn (DE); Thomas Muhr, Attendorn (DE)

Correspondence Address: Wyatt, Gerber & O'Rourke, LLP, 99 Park Avenue, New York, NY, 10016, US

(21) Appl. No.: 11/190,235

(22) Filed: Jul. 27, 2005

(30) Foreign Application Priority Data
Jul. 30, 2004 (DE) 10 2004 037 206.3

(51) Int. Cl. B60R 19/34

(52) U.S. Cl. 293/133

(57) ABSTRACT

A motor vehicle body which is joined together out of individual elements, more particularly hollow profiles and planar elements consisting of sheet metal, wherein use is made of at least some individual elements consisting of flexibly rolled sheet metal whose sheet metal thickness varies along one direction and in the case of which the distribution width of the specific load across the individual element is reduced or minimized by the selection of the sheet metal thickness distribution.

### BACKGROUND OF THE INVENTION

The invention relates to a motor vehicle body which is made of joined individual elements, more particularly hollow profiles and planar elements consisting of sheet metal, as well as to a method of designing such motor vehicle bodies. A motor vehicle body in this context is to be interpreted as meaning a body, bonnets and doors can be included.

It is known to produce motor vehicle bodies from individual elements with different sheet thicknesses. Furthermore, use has been made of sheet metal elements in motor vehicles which comprise variable sheet thicknesses in order to achieve, in the case of an accident, a certain deformation behavior in terms of time and/or space.

With reference to the body strength in connection with the use of a given material, more particularly the torsional stiffness, attempts are continuously made to improve the vehicle structure, i.e. the shape of the motor vehicle body.

### OBJECTS OF THE INVENTION

It is the object of the present invention to provide a new method of optimizing the use of material in motor vehicle bodies. A first solution consists in making use, at least partially, of individual elements consisting of flexibly rolled sheet metal whose sheet thickness is variable along one axis, more particularly in the direction of its longitudinal extension corresponding to the direction of rolling the sheet metal, wherein the spectrum (distribution width) of the specific load across the individual element under driving conditions, when subjected to elastic deformation, is reduced or minimized by the selection of the sheet metal thickness distribution. This means that those parts of a sheet metal element which, if comprising a constant sheet metal thickness, would be subjected to a lower specific load, are provided with a lesser sheet thickness within the sheet metal element. This allows a reduction in the amount of material used without greatly adversely affecting the corrosion strength because the strength limits continue to be observed. The lesser sheet thickness is achieved by the flexible rolling process resulting in a variable sheet thickness along one axis.

### SUMMARY OF THE INVENTION

More particularly, it is proposed that the selection of the sheet thickness distribution is adapted to the load under driving conditions in the case of which only elastic deformation is permitted to occur.

A second solution consists in that, at least partially, use is made of individual elements consisting of flexibly rolled sheet metal whose plate thickness is variable along one axis, more particularly in the direction of its longitudinal extension corresponding to the direction of rolling the sheet metal, wherein the spectrum (distribution width) of the specific load in the case of a crash, under plastic deformation across the individual element, is increased or maximized by the selection of the sheet metal thickness distribution.

This means that for certain individual elements, the selection of the sheet thickness distribution is adapted to the load applied in the case of a crash in the case of which an optimized plastic deformation is to occur, with deformation taking place specifically and in a predetermined way in the regions of reduced or minimized sheet thickness. More particularly, this applies to those individual elements which mainly are to accommodate energy in the case of a crash.

The weight of each motor vehicle body or each body part has to be optimized in accordance with the load to which it is subjected So far, the local maximum load has determined the minimum sheet thickness of the individual elements of the structure to be built. On the one hand, use is made of a tailor-welded blanks (welded together from sheets of different thickness) in order to be able to use in the structure individual sheets with different sheet thicknesses and, optionally, different materials which have to be connected to one another by welds. On the other hand, use is made of local reinforcement sheets or gusset plates on individual elements for the purpose of contributing to an improved structure. In accordance with the invention, this can be achieved by using instead one-piece individual elements of flexibly rolled sheet or profiles or tubes produced therefrom. Whereas tailor-welded blanks and reinforcement sheets suffer form thickness jumps, the invention achieves load-optimized flowing thickness transitions while at the same time avoiding weakening welds. The number of joints required in the structure can be reduced.

In accordance with the invention, it is possible, with the help of flexible rolling, to produce load-optimized wall thicknesses in such a way that they are characterized by flowing, harmonious changes in thickness Said harmonious sheet thickness curve characteristic of the individual component is defined by the specific load case. However, the load case is not a localized parameter, with reference to the individual component, but the load case of the individual component is defined by the load applied to the entire vehicle body structure. This means that when optimizing the sheet thickness of the individual component, the behavior of the entire structure always has to be taken into account. It is therefore necessary to provide an optimizing tool which effects the load optimization of the individual component, taking into account the entire structure. Optimization criteria for a load-specific design, on the one hand, can be identical functional component characteristics accompanied by low weight or better functional characteristics accompanied by identical weights and, on the other hand, an optimum crash behavior with a lower weight or an improved crash behavior with identical weights.

The weight-and-stiffness-optimized vehicle body structure based on flowing changes in sheet thickness has to be determined in such a way that the changes in sheet thickness are calculated by an optimization algorithm which always optimizes the function of, or load on, the individual component with reference to he entire vehicle body structure.

According to one embodiment of the invention it is proposed that at least one of the following individual elements consists of flexibly rolled sheet metal which is adapted to the load applied under driving conditions:
cross member rear axle
cross member front axle
cross member end face wall
roof cross member
reinforcement bonnet
seat cross member front seat cross member rear
cross member rear seat
cockpit cross member.

In this case, more particularly the axial ends and/or special connecting regions are provided with a greater material thickness as compared to the remaining regions.

Furthermore, it is proposed according to a future embodiment that at least one of the following individual elements consists of flexibly rolled sheet metal which is adapted to the load applied in the case of a crash:
side member front/side member rear
bumper
door sill
B-column
door impact beam
reinforcement transmission tunnel
reinforcement tunnel
closing part of B-column
roof frame front/roof frame rear.

More particularly, it is proposed that there takes place a frequent change between regions of a greater material thickness and those of a lesser material thickness along the length of the sheet.

According to a yet a further embodiment it is proposed that at least the following individual elements which adjoin one another, in a combined form, consist of flexibly rolled sheet metal:
side member I and side member II
side member and closing part of side member
cross member and closing part of cross member
B-column and closing part of B-column.

Finally, it is proposed that at least the following individual elements, in a combined form, consist of flexibly rolled sheet metal and of welded sheets of different thicknesses (tailor-welded blanks):
inner door sheet
side frame
floor sheet front
floor sheet rear
cross member end face wall
outer door sheet.

The individual elements can be joined to one another by welding and/or clinching and/or gluing.

According to a further aspect of the invention, there is proposed a method of designing a motor vehicle body which is joined together of individual elements, more particularly of hollow profiles and planar elements consisting of sheet metal, which is characterized in that the strength calculation is based on individual sheet metal elements with a constant sheet thickness and that the spectrum (the distribution width) of the specific load applied at least to individual elements under driving conditions under elastic deformation is reduced or minimized by the use of flexibly rolled sheet whose sheet thickness is variable.

According to a further aspect of the invention there is proposed a method of designing a motor vehicle body which is joined together of individual elements, more particularly of hollow profiles and planar elements consisting of sheet metal, in the case of which the strength calculation is based on individual sheet metal elements with a constant sheet thickness and wherein the distribution width of the specific load applied at least to individual elements for accommodating energy in the case of a crash under plastic deformation is increased or minimized by the use of flexibly rolled sheet whose sheet thickness is variable along one direction.

More particularly, it is proposed in connection with both the above-mentioned cases that the strength calculation is carried out repetitiously and optimized while observing the limits of feasibility of flexibly rolled sheet with a variable sheet thickness and while observing the material strength limits. When undertaking the design work it has to be taken into account that the specific bending load inside an individual element so of flexibly rolled sheet is contained within a spectrum (a distribution width) of ±10%. Furthermore, it has to be taken into account that the specific tensile load/compressive load inside an individual element so flexibly rolled sheet is contained within a spectrum (a distribution width) of ±20%.

### BRIEF DESCRIPTION OF THE DRAWINGS

FIG. 1 illustrates individual parts of a motor vehicle body in an exploded view.

FIG. 2 illustrates a bar graph of the sheet thickness curve of a B-column.

FIG. 3 illustrates a bar graph of the sheet thickness curve of a side sill member.

FIG. 4 illustrates a bar graph of the sheet thickness curve of a rear cross member.

FIG. 5 illustrates a bar graph of the sheet thickness curve of a front cross member.

FIG. 6 illustrates a bar graph of the sheet thickness curve of a door impact member.

FIG. 7 illustrates a bar graph of the sheet thickness curve of hinge reinforcement.

### DETAILED DESCRIPTION

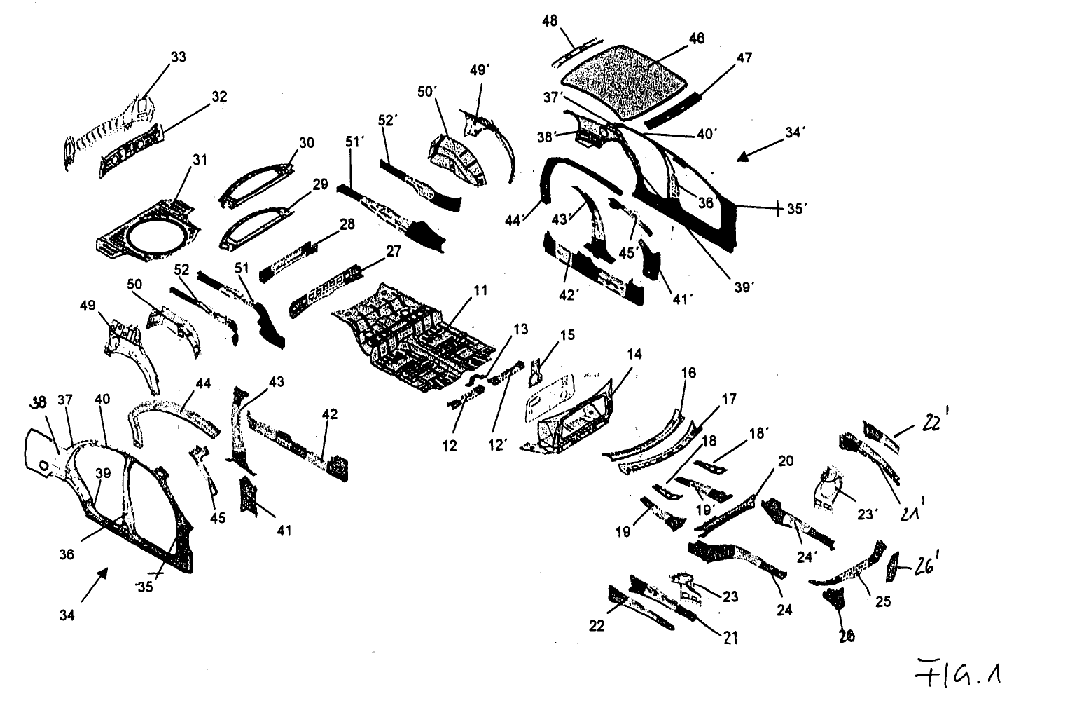

The most important parts of a motor vehicle body in an exploded view are illustrated in FIG. 1, with the parts of the vehicle rear being arranged on the top left-hand side of the Figure and the parts of the vehicle front being arranged on the bottom right-hand side of the Figure. Greater sheet thicknesses are indicated by darker colors and lesser sheet thicknesses by lighter colors. Those parts whose sheet thickness is variable and which thus show different degrees of brightness are produced in one piece from flexibly rolled sheet metal.

A floor plate 11 is produced from a metal sheet of a constant thickness; it has been give a uniform color in the illustration. The same applies to a tunnel bridge 13. Seat cross members 12, 12′ to be placed on the floor plate are produced from a flexibly rolled metal sheet which comprises a greater thickness at its ends. Towards the front, the floor plate 11 is followed by an end face wall 14 with a central reinforcement 15 which each consist of a metal sheet with a constant thickness. The edges of the end face wall are followed by an upper cross member 16 and a lower cross member 17. These, too, consist of a metal sheet with a constant thickness. Furthermore, the end face wall is followed by side members II, 19, 19′ with their closing parts 18, 18′ whose ends comprise a greater thickness than the central region. Said ends are connected to one another by a front transverse member 20. The ends of upper side members 21, 21′ with their closing parts 22, 22′ each comprise a greater thickness than the central region, with receiving means for spring strut domes 23, 23′ being connected to said ends. Side members I 24, 24′ consist of a flexibly rolled material with the ends of same comprising a greater thickness than the central region. A front cross member 25 for receiving the lock connects the front free ends of the upper side members, with front closing plates 26, 26′ being connected to said free ends. Said cross member 25 for receiving the lock, at its ends, comprises a greater thickness than the central region. In the rear region of the floor plate 11, there is positioned a cross member 27 underneath the rear seats, also a cross member 28 for receiving the real axle. The ends of both comprise a greater thickness than the central region. Furthermore, it is possible to identify a lower hat receiving frame 29 and an upper hat receiving frame 30, each consisting of sheet metal with a constant sheet metal thickness. These will be connected to side parts to be described later. A boot floor plate 31 is attached directly to the floor plate 11 and, in turn, carries an inner boot terminating plate 32 and a rear skirt 33, both consisting of sheet metal with a constant thickness. Furthermore, side frame parts 34, 34′ consisting of flexibly rolled sheet metal are attached to the floor plate 11, with further details consisting of the A-column 35, 35′, the B-columns 36, 36′, the C-columns 37, 37′ and the rear mud guards 38, 38′. Between the A-column and the C-column, there are arranged the door sills 39, 39′ and the upper door frames 40, 40′. As can be seen, the B-columns consist in their central region of a thinner material and in the connecting regions at the door sills 39, 39′ and at the upper door frames 40, 40′ of a thicker material. If viewed in the longitudinal direction, the door sills 39, 39′ each comprise end regions with a greater thickness and a region of a lesser material thickness in the connecting region of the B-columns and the C-columns.

A lower closing part for the A-column 41, 41′ and an upper closing part for the A-column 45, 45′, a door sill plate 42, 42′, a closing part for the B-column 43, 43′ and a roof frame profile 44, 44′ are positioned against the side frame parts 34, 34′ from the inside. In this case, too, it is possible to identify different sheet thicknesses, i.e. on the plates 42, 42′ reinforcements in the front and rear as well as in the center, at the plates 43, 43′ and 45, 45′ reinforcements at their two ends and at the plates 44, 44′ reinforcements in the connecting regions. Furthermore, there is shown a roof plate 46 consisting of a substantially uniformly thick sheet as well as front and rear roof cross members 47, 48 each consisting of a sheet material with a constant thickness. There are also shown mud guard inserts 49, 49′, 50, 50′ which also largely consist of a sheet material with a constant thickness. Furthermore, rear side members 51, 51′ with closing parts 52, 52′ consisting of flexibly rolled sheet metal are attached to the floor plate 11. In each case, the ends, in the longitudinal direction, are provided with greater sheet thicknesses than in the central region.

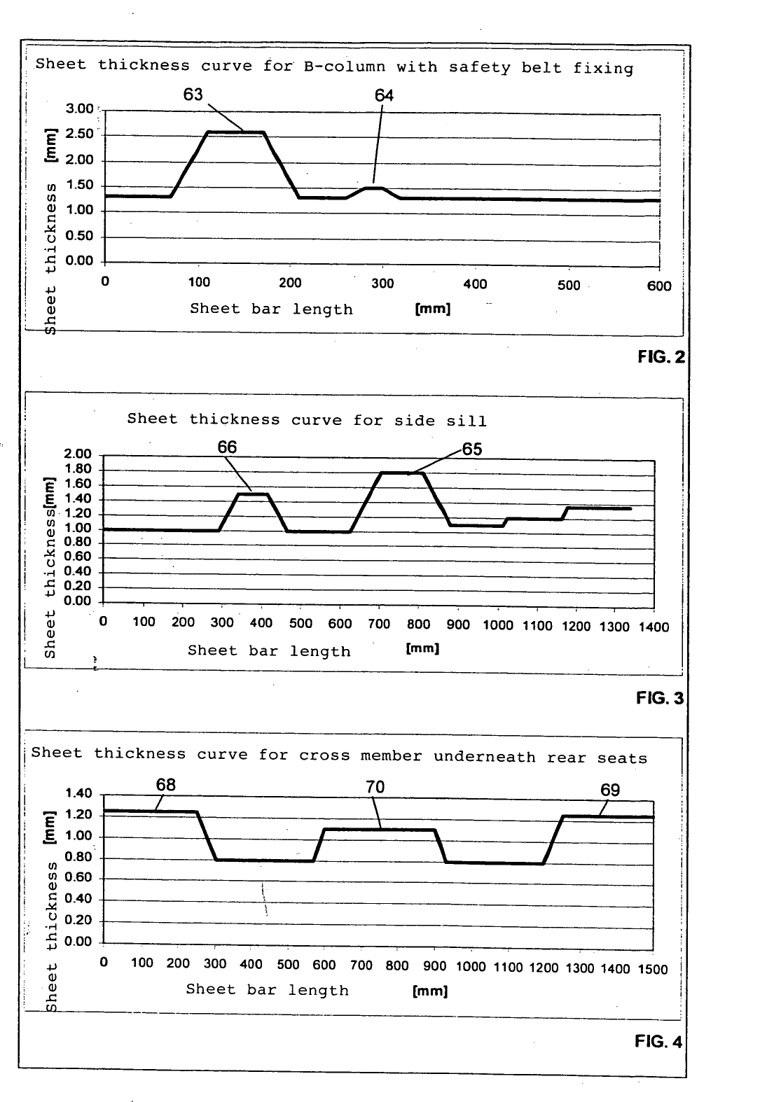

FIG. 2 shows a longitudinally extending sheet thickness curve for a B-column. There are shown sheet thickness reinforcements 63 for safety belt roller fixing means and 64 for safety belt deflecting fixing means, with the remaining part of the curve indicating a constant sheet thickness. Whereas the smallest sheet thickness amounts to approximately 1.3 mm, the sheet thickness in the region of the larger reinforcement 63 amounts to approximately 2.6 mm and in the region of the smaller reinforcement it amounts to approximately 1.5 mm. This applies to a total length of approximately 600 mm.

FIG. 3 shows the sheet thickness curve for a longitudinal sill. It is possible to identify a sheet thickness reinforcement 65 in the region of the A-column connection and a sheet thickness reinforcement 66 in the region of the B-column connection. Towards the front, beyond the A-column connection, the sheet thickness increases in two steps, the smallest sheet thickness amounting to approximately 1.0 mm, whereas the greatest sheet thickness amounts to approximately 1.8 mm. This applies to a total length of approximately 1,350 mm.

FIG. 4 shows the sheet thickness curve for a cross member underneath the rear seats. There is provided a sheet thickness reinforcement 70 in the center and further sheet thickness reinforcements 68, 69 for the connection points at the outer ends. The smallest sheet thickness amounts to 0.8 mm, whereas the greatest sheet thicknesses amount to 1.25 mm. This applies to a total length of approximately 1,500 mm.

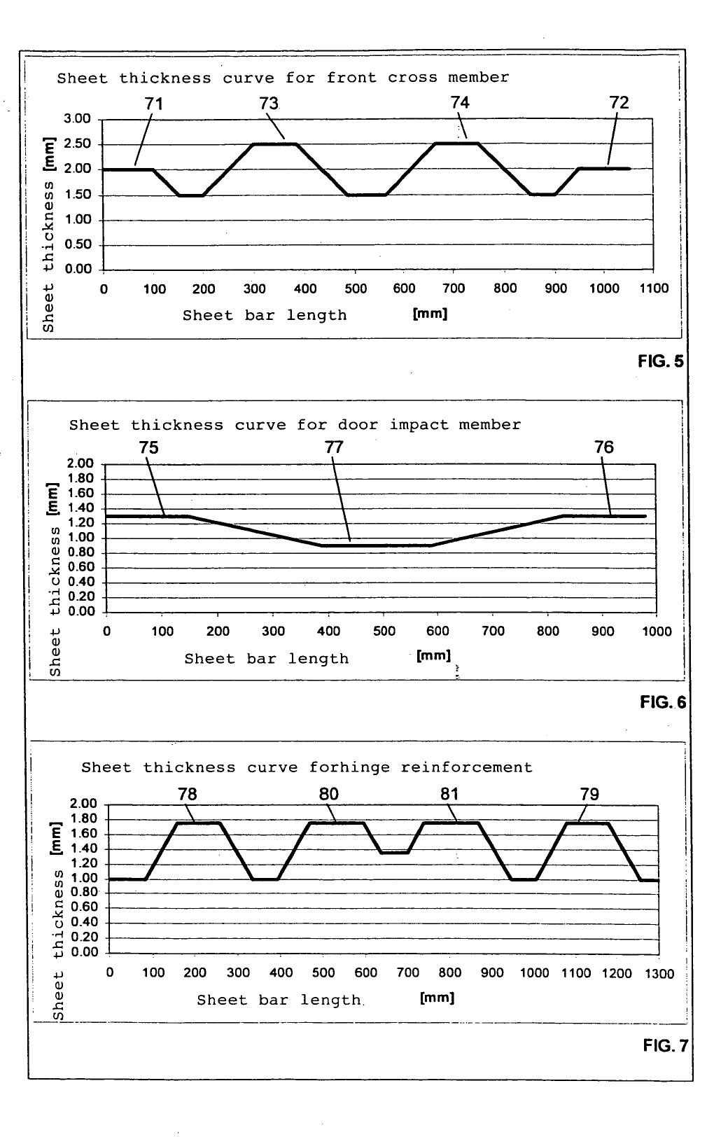

FIG. 5 shows the sheet thickness curve for a front cross member. It is possible to identify smaller sheet thickness reinforcements 71, 72 at the outer ends for connection points and two symmetrically arranged sheet thickness reinforcements 73, 74 in the intermediate region. The smallest sheet thickness amounts to approximately 1.5 mm and the greatest sheet thickness to approximately 2.5 mm. The total length is approximately 1,050 mm.

FIG. 6 shows the sheet thickness curve for a door impact member which, in the longitudinal direction of the vehicle, has to be inserted into a vehicle door. There are provided sheet thickness reinforcements 75, 76 at both ends, whereas in the central region, there is provided a reduced sheet thickness 77. The smallest sheet thickness amounts to approximately 0.8 mm, whereas the greatest sheet thickness amounts to approximately 1.3 mm. The transition lengths each amount to in excess of 200 mm with a total length of approximately 1,000 mm.

FIG. 7 shows the sheet thickness curve for a hinge reinforcement which can be attached to A-columns or B-columns. In this case, there are formed flowing thickness transitions which extend along long parts of the length. It is possible to see two outer sheet thickness reinforcements 78, 79 and two central sheet thickness reinforcements 80, 81 which extend symmetrically along the length of the sheet. The smallest thickness amount to 1.00 mm, whereas the greatest sheet thickness amount to approximately 1.75 mm. This applies a total length of approximately 1,300 mm.

I claim:

1. A motor vehicle body which is joined together out of individual elements consisting of sheet metal, characterized in that use is made of at least some individual elements made from flexibly rolled sheet metal whose sheet metal thickness is variable along one direction and in the case of which individual elements made from flexibly rolled sheet metal the distribution width of the specific load across the individual element is reduced or minimized by the selection of the sheet metal thickness distribution.

2. A motor vehicle body according to claim 1, characterized in that the selection of the sheet metal thickness distribution is adapted to the load applied during driving under elastic deformation.

3. A motor vehicle body which is joined together out of individual elements consisting of sheet metal, characterized in that use is made of at least some individual elements made from flexibly rolled sheet metal whose sheet metal thickness is variable along one direction and in the case of which individual elements made from flexibly rolled sheet metal the distribution width of the specific load across the individual element is increased or maximized by the selection of the sheet metal thickness distribution.

4. A motor vehicle body according to claim 3, characterized in that the selection of the sheet metal thickness distribution is adapted to the load applied in the case of a crash under plastic deformation.

5. A motor vehicle body according to any one of claims 1 or 2, characterized in that at least one of the following individual elements consists of flexibly rolled sheet metal which is adapted to the load applied under elastic deformation during driving:
cross member rear axle
cross member front axle
cross member end face wall
roof cross member
reinforcement bonnet
seat cross member front/seat cross member rear
cross member rear seat
cockpit cross member.

6. A motor vehicle body according to any one of claims 3 or 4, characterized in that at least one of the following individual elements consists of flexibly rolled sheet metal which is adapted to the load applied under plastic deformation in the case of a crash:
side member front/side member rear
bumper
door sill
B-column
door impact member
reinforcement transmission tunnel
reinforcement tunnel
closing part of B-column
roof frame front/roof frame rear.

7. A motor vehicle body according to any one of claims 1 to 4, characterized in that the individual elements are joined by at least one of welding and clinching and gluing.

8. A motor vehicle body according to any one of claims 1 to 4, characterized in that at least two each of the following individual elements, in a combined form, consist of flexibly rolled sheet metal:
side member 1 and side member II
side member and closing part of side member
cross member and closing part of cross member
B-column and closing part of B-column.

9. A motor vehicle body according to any one of claims 1 to 4, characterized in that at least the following individual elements, in a combined form, consist of flexibly rolled sheet metal or welded sheets of different thicknesses (tailor-welded blanks):
inner door plate
side frame
floor plate front
floor plate rear
cross member end face wall
outer door plate.

10. A method of designing a motor vehicle body which is joined together of individual elements consisting of sheet metal, characterized in that the strength calculation is based on individual sheet metal elements with a constant sheet thickness and that the distribution width of the specific load applied at least to individual elements under driving conditions under elastic deformation is reduced or minimized by the use of flexibly rolled sheet whose sheet thickness is variable along one direction.

11. A method of designing a motor vehicle body which is joined together of individual elements consisting of sheet metal, characterized in that the strength calculation is based on individual sheet metal elements with a constant sheet thickness and that the distribution width of the specific load applied at least to individual elements for accommodating energy in the case of a crash under plastic deformation is increased or maximized by the use of flexibly rolled sheet whose sheet thickness is variable along one direction.

12. A method according to any one of claims 10 or 11, characterized in that the strength calculation is carried out repetitiously and optimized while observing the limits of feasibility of flexibly rolled sheet with a variable sheet thickness and while observing the material strength limits.

13. A method according to any one of claims 10 or 11, characterized in that the specific bending load inside an individual element of flexibly rolled sheet is contained within a distribution width of ±10%.

14. A method according to any one of claims 10 or 11, characterized in that the specific tensile load or compressive load inside an individual element of flexibly rolled sheet is contained within a distribution width of ±20%.
